(19) United States
(12) Patent Application Publication
(10) Pub. No.: US 2009/0186558 A1
(43) Pub. Date: Jul. 23, 2009

(54) GRINDING METHOD, GRINDING DEVICE AND ELECTRODE THEREFOR

(75) Inventor: Ricardo Itiro ORI, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/357,959

(22) Filed: Jan. 22, 2009

(30) Foreign Application Priority Data
Jan. 23, 2008 (JP) 2008-012723

(51) Int. Cl. B24B 53/00; B24B 53/06; B24B 53/095; B23H 7/22; B23H 7/26

(52) U.S. Cl. 451/21; 451/56; 451/259; 204/224 M; 204/280

(57) ABSTRACT

A grinding device including a multi-wheel grindstone and an electrode arranged opposite to a grinding action surface of the multi-wheel grindstone with an interval, in which a work is ground and machined while the grinding action surface of the multi-wheel grindstone is electrolytic-dressed by supplying conductive machining fluid between an electrode action surface of the electrode and the grinding action surface of the multi-wheel grindstone, and applying a voltage between the multi-wheel grindstone and the electrode, wherein the electrode has a laminate body in which electrode plates whose electrode action surfaces are arranged so as to oppose the grinding action surface of each of the grinding wheels are alternately sandwiched by a plurality of insulating plates; and a flow passage for distributing the machining fluid supplied to between the grinding action surface and the electrode action surface is formed at the electrode plate and the insulating plate.

### BACKGROUND OF THE INVENTION

1. Field of the Invention

The present invention relates to a grinding device and a grinding method and particularly to an art of grinding and machining a work while a grinding action surface of a multi-wheel grindstone is electrolytically dressed (toothing).

2. Description of the Related Art

It has been known that a high-intensity metal bonded superabrasive grindstone such as a cast-iron fiber bond diamond grindstone and the like is suitable for ultraprecise machining of high-hardness intractable (hard-to-work) material such as ceramics and the like. And as a highly efficient grinding method using this high-intensity metal bonded superabrasive grindstone, an electrolytic in-process dressing (hereinafter referred to as “ELID”) grinding method has attracted attention.

In the ELID grinding method, a grindstone is dressed by (in-process) electrolytic action while grinding machining. In order to uniformly apply this electrolytic action on a grinding action surface of the grindstone, in Japanese Patent Application Laid-Open No. 2002-1658, for example, in the ELID grinding device, provision of a plurality of electrode segments for electrolytic dressing of portions different from each other on an outer circumferential face and a side face of the grindstone is proposed.

In Japanese Patent Application Laid-Open No. 6-143134, for uniform electrolytic dressing of a grindstone, provision of a fluid reservoir for uniformly flowing a machining fluid between the grindstone and an electrode is proposed.

In Japanese Patent Application Laid-Open No. 9-57622, in the ELID grinding device, a method for efficiently carrying out processes from rough machining to finish machining by forming a multi-wheel grindstone in which a plurality of grinding wheels with different abrasive grain densities and sizes are arranged on a rotating shaft without a gap and by moving an action surface of the multi-wheel grindstone with respect to a work, is proposed.

In Japanese Patent Application Laid-Open No. 10-225865, in order to reduce a size of a power supply in an ELID grinding device, a method for switching conduction for respective electrode plates by providing an insulating plate between a plurality of electrode plates, is proposed.

### SUMMARY OF THE INVENTION

However, as in the above Japanese Patent Application Laid-Open No. 9-57622, the use of a grindstone in which different types of grinding wheels for rough machining, semi-finishing and final finishing are integrated without a gap is not practical and it has been desired that grains of a desired density and size can be freely combined for use.

On the other hand, when different types of grinding wheels are arranged side by side with a gap, particularly if a grinding-wheel thickness is extremely thin and a gap between the grinding wheels is small, there is a problem that a machining fluid is difficult to sufficiently and uniformly spread over a grinding action surface of each grinding wheel in the multi-wheel grindstone. Also, since the shape of the grinding action surface of the grindstone is varied according to a work, if the shape of the grinding action surface of the grindstone becomes complicated, there is a fear that the machining fluid does not spread uniformly over the grinding action surface.

As mentioned above, at grinding machining by assembling a plurality of different types of extremely thin grinding wheels with a predetermined interval, in order to uniformly electrolytic-dress each grinding action surface, a machining fluid should be supplied uniformly and sufficiently to the grinding action surface of each grinding wheel. However, in the above Japanese Patent Application Laid-Open Nos. 2002-1658, 6-143134, 9-57622, and 10-225865, no consideration is given to a method of uniformly supplying and holding the machining fluid between an action surface of each of a plurality of electrode plates and each grinding action surface.

The present invention was made in view of the above circumstances and has an object to provide a grinding method and a grinding device in which a grinding action surface of each grinding wheel can be uniformly electrolytic-dressed since at the grinding machining using a multi-wheel grindstone in which a plurality of different types of extremely thin grinding wheels are assembled with a predetermined interval, since a conductive machining fluid can be uniformly and sufficiently supplied to each grinding wheel.

A first aspect of the present invention provides, in order to achieve the above object, a grinding device including a multi-wheel grindstone in which a plurality of conductive disk-shaped grinding wheels are arranged side by side with a predetermined interval along a rotating shaft and an electrode arranged opposite to a grinding action surface of the multi-wheel grindstone with an interval, in which a work is ground and machined while the grinding action surface of the multi-wheel grindstone is electrolytic-dressed by supplying conductive machining fluid between an electrode action surface of the electrode and the grinding action surface of the multi-wheel grindstone, and applying a voltage between the multi-wheel grindstone and the electrode, wherein the electrode has a laminate body in which a plurality of electrode plates whose electrode action surfaces are arranged so as to oppose the grinding action surface of each of the grinding wheels are alternately sandwiched by a plurality of insulating plates, and the electrode comprises a flow passage for distributing the machining fluid supplied into the laminate body to between the grinding action surface of each grinding wheel and the electrode action surface of the electrode plate is formed at the electrode plate and the insulating plate.

According to the first aspect, the electrode has a laminate body in which a plurality of electrode plates are alternately sandwiched by a plurality of insulating plates, and a flow passage for distributing the machining fluid supplied into the laminate body to between the grinding action surface of each grinding wheel and the electrode action surface of the electrode plate is formed at the electrode plate and the insulating plate. Therefore, the machining fluid can be surely distributed and supplied between the electrode action surface of each electrode plate and the grinding action surface of each grinding wheel. Accordingly, even in the multi-wheel grindstone in which a plurality of extremely thin grinding wheels are arranged side by side, the machining fluid can be surely supplied to the grinding action surface of each grinding wheel, which can be uniformly electrolytic-dressed.

According to a second aspect of the present invention, in the grinding device according to the first aspect, the flow passage includes: manifolds having an arc shape which are formed in the plurality of insulating plates along a rotating direction of the grinding wheels and expand a flow of the machining fluid introduced into the laminate body in a laminating direction of the laminate body and the rotating direction of the grinding wheels; and channels which are formed as long-hole shaped notch portions at a plurality of positions on the plurality of electrode plates along the rotating direction of the grinding wheels, one end of the notch portions communicating with a corresponding manifold with the other end of the notch portions opened on the electrode action surface of the electrode plates.

In the grinding device according to the second aspect, by the manifold formed on the insulating plate, the flow of the machining fluid is expanded in the rotating direction (including forward and backward) of the grinding wheel, and the machining fluid can be uniformly distributed and supplied from the channel formed on the electrode plate communicating with the manifold to between the electrode action surface and the grinding action surface. Therefore, even in the multi-wheel grindstone in which a plurality of extremely thin grinding wheels are arranged side by side, the machining fluid can be surely supplied to the grinding action surface of each grinding wheel.

According to a third aspect of the present invention, the grinding device according to the second aspect further includes projecting portions inclined toward the rotating direction of the grinding wheels, inside the notch portions forming the channels

In the grinding device according to the third aspect, since the flow passage is narrowed by the projecting portions provided inside the notch portions forming the channels, even if a flow rate of the machining fluid is small, the machining fluid can be supplied at a high flow rate. Also, since the projecting portion is inclined in the rotating direction of the grinding wheel, the machining fluid is hardly sprayed by an air film formed with rotation of the grinding wheel, and the machining fluid can be supplied between that and the grinding action surface of the grinding wheel.

According to a fourth aspect of the present invention, in the grinding device according to the first aspect, the flow passage includes: manifolds which are formed at upstream positions in a rotating direction of the grinding wheels in the plurality of insulating plates and expand a flow of the machining fluid introduced into the laminate body in a laminating direction of the laminate body; and channels which are formed as long-hole shaped notch portions at upstream positions in the rotating direction of the grinding wheels in the plurality of electrode plates, one end of the notch portions communicating with a corresponding manifold with the other end of the notch portions opened on the electrode action surface of the electrode plates.

In the grinding device according to the fourth aspect, since an electrode action area of the electrode plate opposing the grinding action surface can be made relatively large, shortage of electrolysis can be suppressed.

According to a fifth aspect of the present invention, in the grinding device according to any one of the first to fourth aspects, the plurality of insulating plates have distal end portions projecting to the side of the grinding wheel rather than the electrode action surfaces; and a machining-fluid holding space surrounding the grinding action surface for each grinding wheel of the multi-wheel grindstone is formed by the insulating plates which are adjacent with each other and sandwich the electrode plate therebetween.

Thus, the machining fluid is easily held between the grinding action surface and the electrode action surface for each grinding wheel by the adjacent insulating plates, and uniform electrolytic dressing is realized.

According to a sixth aspect of the present invention, in the grinding device according to any one of the first to firth aspects, each of the grinding wheels is a form grinding wheel.

Thus, even if a sectional shape of the grinding action surface is not straight, the machining fluid can be easily held between the grinding action surface of each grinding wheel and the electrode action surface of each electrode plate by the adjacent insulating plates, and uniform electrolytic dressing is realized.

According to a seventh aspect of the present invention, in the grinding device according to any one of the first to sixth aspects, a thickness of each grinding wheel is 5 mm or less.

Thus, even if a plurality of extremely thin grinding wheels are used, the machining fluid can be uniformly supplied to the grinding action surface of each grinding wheel.

According to an eighth aspect of the present invention, in the grinding device according to any one of the first to seventh aspects, roughness of the grinding action surface is different for each grinding wheel.

In this configuration, since the grinding wheels with different roughness are combined in use, rough machining to finish machining can be carried out in series. Therefore, the grinding machining can be carried out efficiently so as to obtain desired surface accuracy and surface roughness. The case where the roughness of the grinding action surface is different includes a case in which one or more of the size of the abrasive grains (grain size) and density of the grains in the grinding action surface are different.

According to a ninth aspect of the present invention, the grinding device according to any one of the first to eighth aspects, further includes a switching device for switching conduction between a power supply for applying a voltage between each grinding wheel and the electrode, and each of the electrode plates.

In the grinding device according to the ninth aspect, since the electrode has a configuration in which a plurality of electrode plates are alternately laminated through a plurality of insulating plates, and a switching device for switching conduction between each electrode plate and the power supply is provided, selective electrolytic dressing is realized. In addition, the electrolytic condition of each wheel can be changed according to each electrode plate, or switched off when not in use.

A tenth aspect of the present invention provides a grinding method for carrying out grinding machining using the grinding device according to any one of the first to ninth aspects, in order to achieve the above object.

According to an eleventh aspect of the present invention, in the method according to the tenth aspect, the work is a distal end portion of a coater head.

According to a twelfth aspect of the present invention, in the method according to the tenth aspect, the work is a distal end portion of a coater head.

Since the grinding wheel can be electrolytic-dressed uniformly and with high accuracy, grinding machining can be carried out with a desired surface accuracy to a work (distal end portion of a coater head and the like) which requires highly-accurate grinding machining such as a distal end portion of a coater head and a distal end portion of a coater head.

To attain the object, a thirteen aspect of the present invention provides an electrode used for a grinding device including a multi-wheel grindstone in which a plurality of conductive disk-shaped grinding wheels are arranged side by side with a predetermined interval along a rotating shaft, the electrode arranged opposite to a grinding action surface of the multi-wheel grindstone with an interval, in which a work is ground and machined while the grinding action surface of the multi-wheel grindstone is electrolytic-dressed by supplying machining fluid between an electrode action surface of the electrode and the grinding action surface of the multi-wheel grindstone, and applying a voltage between the multi-wheel grindstone and the electrode conductive, the electrode comprising: a laminate body in which a plurality of electrode plates whose electrode action surfaces are arranged so as to oppose the grinding action surface of each of the grinding wheels are alternately sandwiched by a plurality of insulating plates, and a flow passage for distributing the machining fluid supplied into the laminate body to between the grinding action surface of each grinding wheel and the electrode action surface of the electrode plate is formed at the electrode plate and the insulating plate.

According to the thirteenth aspect of the present invention, the electrode includes a laminate body in which a plurality of electrode plates whose electrode action surfaces are arranged so as to oppose the grinding action surface of each of the grinding wheels are alternately sandwiched by a plurality of insulating plates, and a flow passage for distributing the machining fluid supplied into the laminate body to between the grinding action surface of each grinding wheel and the electrode action surface of the electrode plate is formed at the electrode plate and the insulating plate. The object of the present invention can also be solved by replacing, with the electrode according to the thirteenth aspect, an electrode used in a conventional grinding device with a multi-wheel grindstone in which a work being ground and machined while the grinding action surface of the multi-wheel grindstone is electrolytic-dressed by supplying machining fluid between an electrode action surface of the electrode and the grinding action surface of the multi-wheel grindstone.

According to any one of the aspects of the present invention, since the conductive machining fluid can be uniformly and sufficiently supplied to each grinding wheel of the multi-wheel grindstone, the grinding action surface of each grinding wheel can be uniformly electrolytic-dressed.

### BRIEF DESCRIPTION OF THE DRAWINGS

FIG. 1 is a perspective view illustrating an example of an entire configuration of a grinding device in an embodiment;

FIG. 2 is a 2-2 line sectional view of a multi-wheel grindstone in the embodiment;

FIG. 3 is an enlarged sectional schematic view of the vicinity of an action surface of a conductive grindstone in the embodiment;

FIG. 4 is a perspective view illustrating an example of a configuration of an electrode for electrolysis in the embodiment;

FIG. 5 is an exploded perspective view illustrating an internal structure of the electrode for electrolysis in the embodiment;

FIG. 6 is a sectional schematic view illustrating a variation of an electrode plate in the embodiment;

FIG. 7 is a sectional schematic view illustrating a variation of an electrode plate in the embodiment; and

FIGS. 8A to 8C are sectional schematic views illustrating variations of the vicinity of the action surface of the electrode for electrolysis in the embodiment.

### DETAILED DESCRIPTION OF THE PREFERRED EMBODIMENTS

A preferred embodiment of a grinding device and a grinding method according to the present invention will be described below referring to the attached drawings.

This embodiment will be described using an example in which a blade distal end portion (work) of a blade coater is dressed with a flat grindstone, while the grindstone is being dressed by an in-process electrolytic action. It is needless to say that the present invention is not limited to this embodiment but can be applied to various works and the like.

First, an outline of a grinding device according to the present invention will be described.

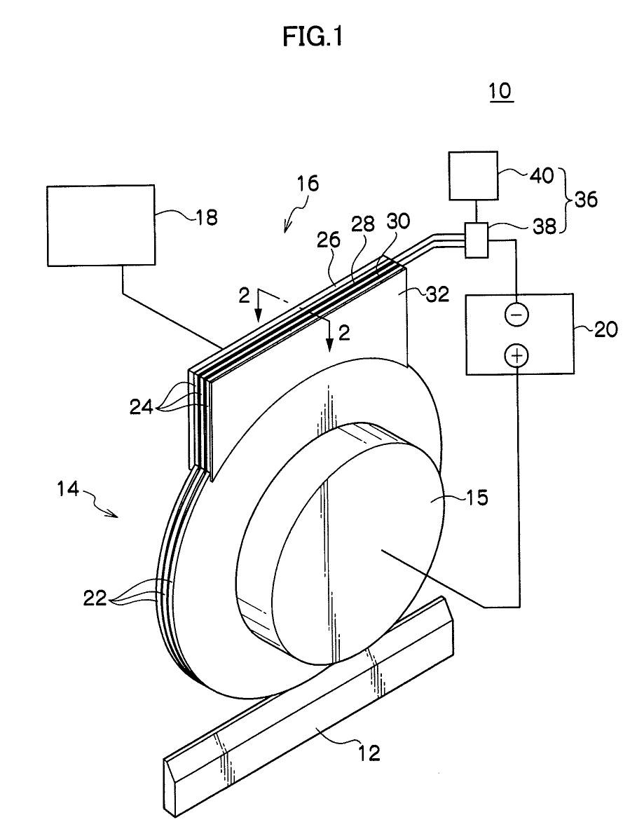

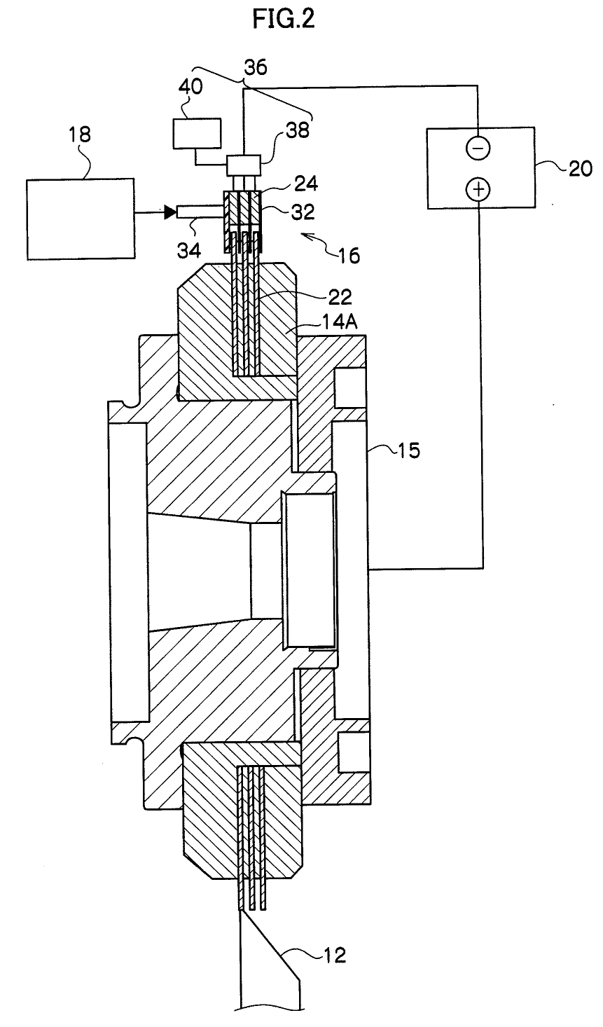

FIG. 1 is a perspective view illustrating an example of an entire configuration of a grinding device 10 in this embodiment. FIG. 2 is a 2-2 line sectional view of the grinding device 10 in FIG. 1.

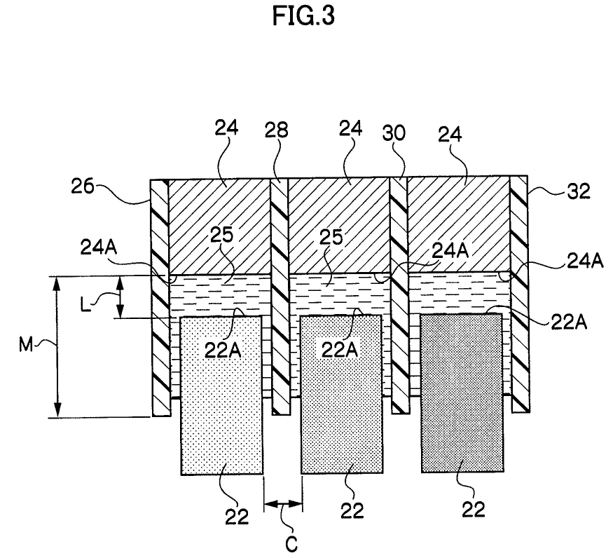

As shown in FIG. 1, the grinding device 10 comprises a multi-wheel grindstone 14 provided with a plurality of conductive grinding wheels 22 with different roughness for grinding machining of a work 12, an electrode 16 for electrolysis arranged opposite to a grinding action surface 22A (See FIG. 3) of the conductive grinding wheels of the multi-wheel grindstone 14 for electrolysis for electrolytic-dressing of the grinding action surface 22A, a machining-fluid supply portion 18 for supplying a conductive machining fluid between the grinding action surface 22A of the multi-wheel grindstone 14 and the electrode 16 for electrolysis, and a power supply 20 for applying a voltage between the grinding action surface 22A of the multi-wheel grindstone 14 and the electrode 16 for electrolysis.

In the multi-wheel grindstone 14, the disc-shaped conductive grinding wheels 22 with different roughness are arranged in plural side by side on a rotating shaft 15 of a holder 14A (three wheels in FIG. 1) and configured to be rotated and driven by a driving device, not shown. In FIG. 1, the conductive grinding wheels 22 are for rough machining, semi-finishing, and final finishing in the order from the left. A combination of the conductive grinding wheels 22 is not limited to a mode in FIG. 1. A plurality of grinding wheels with the same abrasive grain size but different abrasive grain density on the grinding action surface may be used for each conductive grinding wheel 22, for example. Alternatively, a plurality of the same type of conductive grinding wheels may be used in lamination. The conductive grinding wheels 22 are not limited to the mode in FIG. 1 but may be arranged side by side in two or four or more pieces.

The conductive grinding wheel 22 holds micro diamond abrasive grains with a metal-bonded material having conductivity (various metals such as cast iron, copper, stainless and the like, for example), for example. A thickness of the conductive grinding wheel 22 is not particularly limited but when a distal end portion of a blade is to be ground as the work 12 in this embodiment, for example, it is preferably 0.01 to 5 mm.

The electrode 16 for electrolysis is arranged so as to oppose the grinding action surface 22A of the conductive grinding wheel 22. The electrode 16 for electrolysis is constructed as a laminate body in which a plurality of electrode plates 24 . . . are laminated through insulating plates 26, 28, 30, 32, respectively. The laminate body made of the electrode plates 24 . . . and the insulating plates 26, 28, 30, 32 is assembled by being fastened with a bolt and the like, not shown, for example.

On a left side face of the electrode 16 for electrolysis, as shown in FIG. 2, a supply port 34 for machining fluid connected to the machining-fluid supply portion 18 is formed and configured so that a machining fluid can be introduced between that and the grinding action surface 22A of the conductive grinding wheel 22 through the inside of the electrode 16 for electrolysis. The internal configuration of the electrode 16 for electrolysis will be described later.

The power supply 20 is a direct-current power supply or a direct-current pulse power supply and applies a positive voltage to the conductive grinding wheel 22 and a negative voltage to the electrode 16 for electrolysis. In FIG. 1, the conductive grinding wheel 22 and the holder 14A fixing the conductive grinding wheel 22 are made conductive by being constructed by a conductive material, for example. Between a negative terminal of the power supply 20 and the electrode 16 for electrolysis, a switching device 36 for switching conduction for each electrode plate 24 is provided and configured so that the conduction can be switched for each electrode plate. The switching device 36 includes a relay unit 38 and a controller 40. The relay unit 38 is provided with a plurality of relays corresponding to each of the electrode plates 24, and each of the relays has one terminal connected to the corresponding electrode plate 24 and the other terminal to the power supply 20. The controller 40 includes a programmable controller and configured so that a signal to turn ON an arbitrarily selected relay for an appropriate time can be outputted to each relay.

With the above configuration, after the conductive machining fluid is supplied by the machining-fluid supply portion 18 between the conductive grinding wheel 22 and the electrode 16 for electrolysis, upon receipt of the signal from the controller 40, the corresponding relay in the relay unit 38 is turned ON. When the electrode plate 24 corresponding to this relay and the negative terminal of the power supply 20 are connected and a predetermined voltage is applied between the electrode plate 24 and the conductive grinding wheel 22, the grinding action surface of the conductive grinding wheel 22 is electrolytic-dressed.

As mentioned above, the conductive grinding wheel 22 for grinding the work 12 can be selectively electrolytic-dressed by the switching device 36. Also, by moving the multi-wheel grindstone 14 with respect to the work 12, the grinding machining from rough machining to finish machining can be carried out for the work 12 continuously and efficiently.

As mentioned above, in order to uniformly electrolytic dress the extremely thin conductive grinding wheels 22 arranged side by side with a micro interval, the machining fluid is surely supplied between the grinding action surface 22A of each of the conductive grinding wheels 22 and the electrode action surface 24A (See FIG. 3) of the electrode plate 24. In this case, the machining fluid flows in the rotating direction with rotation of the conductive grinding wheel 22 and supplied to a portion subject to grinding process of the work 12. At the same time, for the uniform electrolytic dressing of the grinding action surface 22A, it is necessary that a state where the machining fluid is filled between the grinding action surface 22A and the electrode action surface 24A is maintained.

In the present invention, by providing the insulating plates 26, 28, 30, 32 at the electrode 16 for electrolysis, in addition to a function to insulate between each of the electrode plates 24, a function to uniformly distribute the machining fluid to each of the electrode plates 24 and to hold it between that and the grinding action surface 22A of the conductive grinding wheel 22 is obtained.

A configuration of the portion of the electrode 16 for electrolysis arranged opposite to the conductive grinding wheel 22 and the electrode 16 for electrolysis, which are main portions of the present invention, will be described below.

FIG. 3 is an enlarged sectional schematic view of the vicinity of the grinding action surface of the conductive grinding wheel 22 on which the electrode 16 for electrolysis is arranged oppositely in FIG. 2.

As shown in FIG. 3, the electrode 16 for electrolysis has a plurality of electrode plates 24 laminated through the insulating plates 26, 28, 30, 32, and distal end portions of the insulating plates 26, 28, 30, 32 are formed so as to project to the grinding wheel side rather than the electrode action surface 24A of the electrode plate 24. When the electrode 16 for electrolysis is mounted to the multi-wheel grindstone 14, the distal end portions of the insulating plates 26 are arranged between the grinding wheels arranged having an interval. Thereby, the grinding action surface 22A of the conductive grinding wheel 22 is contained between the distal end portions of the two insulating plates 26, 28 (insulating plates 28, 30 or the insulating plates 30, 32) adjacent to the electrode plate 24.

Thereby, a machining-fluid holding space 25 for maintaining a state where the machining fluid between the grinding action surface 22A of the conductive grinding wheel 22 and the electrode action surface 24A of the electrode plate 24 for each conductive grinding wheel 22 is formed. FIG. 3 is a diagram of the state where the machining fluid is held in the machining-fluid holding space 25.

A length M of the distal end portions of the insulating plates 26, 28, 30, 32 with respect to the electrode action surface 24A of the electrode plate 24 is formed at least longer than the maximum interval L between the electrode action surface 24A of the electrode plate 24 and the grinding action surface 22A of the conductive grinding wheel 22 and is formed longer than the maximum interval L by approximately 1 to 20 mm or preferably by approximately 10 mm, for example.

In uniformly electrolytic dressing the grinding action surface 22A of the conductive grinding wheel 22, the maximum interval L between the grinding action surface 22A of the conductive grinding wheel 22 and the electrode action surface 24A of the electrode plate 24 is preferably 100 to 500 μm. An interval C between the adjacent conductive grinding wheels 22 is preferably 0.1 to 5 mm, for example, more preferably 0.5 to 2 mm, or further preferably 1 mm.

As a material of the electrode plate 24, various metals having conductivity such as copper, stainless and the like can be used. A thickness of the electrode plate 24 is formed so as to be larger than the thickness of the conductive grinding wheel 22.

As for the insulating plates 26, 28, 30, it is only necessary that it is an insulating material, and an acrylic resin, various rubber materials and the like can be preferably used, for example.

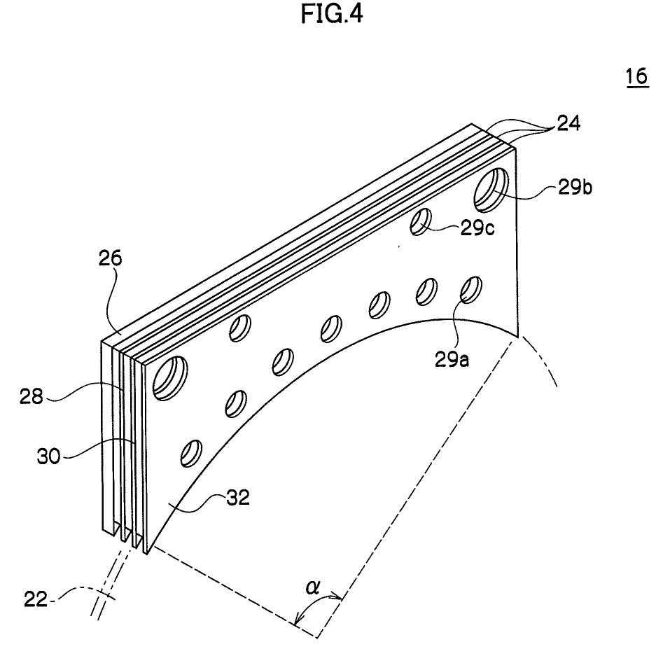

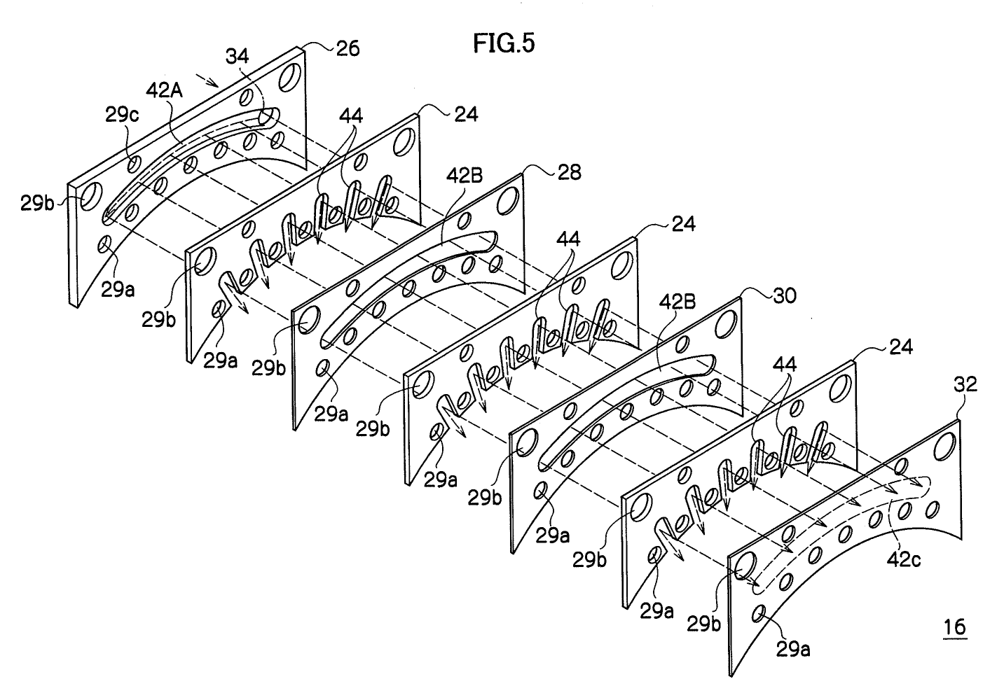

FIG. 4 is a perspective view illustrating an example of a configuration of the electrode 16 for electrolysis according to the present invention. FIG. 5 is an exploded perspective view illustrating an internal structure of the electrode 16 for electrolysis in FIG. 4.

As shown in FIG. 4, in the electrode 16 for electrolysis, the electrode plates 24 and the insulating plates 26, 28, 30, 32 are alternately laminated and configured so as to be fixed by inserting a bolt into bolt holes 29a, 29b, 29c formed in each of the electrode plate 24 and the insulating plates 26, 28, 30, 32.

The distal end portions of the electrode plates 24 and the insulating plates 26, 28, 30, 32 are formed in the arc shape opposed substantially in parallel to the arc-shaped grinding action surface 22A of the conductive grinding wheel 22 and are formed so that the arc-shaped distal end portions of the insulating plates 26, 28, 30, 32 project from the arc-shaped electrode action surface 24A of the electrode plate 24 by a predetermined length on a section in the laminating direction. The electrode action surface 24A of the electrode 16 for electrolysis is preferably provided so that a center angle α of an arc of the conductive grinding wheel 22 corresponding to a portion where the electrode 16 is provided is 90 degrees or more.

A flow passage for distributing the machining fluid supplied into the laminate body to between the grinding action surface of each grinding wheel and the electrode action surface of the electrode plate is formed at the electrode plates 44 and the insulating plates 26,28,30,32. As shown in FIG. 5, the flow passage includes a plurality of manifolds 42A, 42B, 42B and 42C, and a plurality of channels 44. More specifically, on a surface of the insulating plate 26 opposed to the electrode plate 24, an arc-shaped manifold 42A in a long groove shape is formed along the rotating direction of the conductive grinding wheel 22, and a supply port 34 of the machining fluid is formed at one end of a manifold 42A. At two insulating plates 28, 30, manifolds 42B in the same shape as that of the manifold 42A are formed as through holes. On a surface of the insulating plate 32 opposed to the electrode plate 24, a long-groove shaped manifold 42C similar to the manifold 42A is formed. No hole corresponding to the supply port 34 is formed in the manifold 42C.

On the other hand, the plurality of electrode plates 24 are all formed in the same shape. More specifically, channels 44 are formed as long-hole-shaped notch portions at a plurality of positions on the electrode plates 24, and arranged along a rotating direction of the grinding wheel. One ends of the notch portions forming the channels 44 communicate to each of the manifolds 42A, 42B, 42C while the other ends are opened in the electrode action surface 24A of the electrode plate 24. Thereby, the electrode plate 24 is formed in the comb-tooth shape.

As a result, as shown by a dotted line in FIG. 5, a flow of the machining fluid introduced from the supply port 34 into the laminate body is expanded through the manifolds 42A, 42B, 42B, 42C formed in the insulating plates 26, 28, 30, 32 in the laminating direction of the laminate body and the rotating direction of the conductive grinding wheel 22. And the machining fluid whose flow was expanded is distributed from each of the manifolds 42A, 42B, 42B, 42C to the channels 44, 44, . . . of each electrode plate 24 and uniformly supplied to the machining-fluid holding space 25 formed for each conductive grinding wheel 22 of the multi-wheel grindstone 14. By forming the plurality of channels 44, 44, . . . at the electrode plates 24, the machining fluid can be uniformly supplied in the rotating direction of the conductive grinding wheels 22.

The shape and the number of the channels 44 are not limited to the mode in FIG. 5 but may be anything as long as the machining fluid can be sufficiently supplied between the electrode action surface 24A and the grinding action surface 22A and an electrolytic area can be ensured.

As mentioned above, since it is configured so that the machining fluid can be uniformly distributed inside the laminate body constituting the electrode 16 for electrolysis and sufficiently supplied between that and each grinding action surface 22A, each of the grinding action surfaces 22A does not run short of electrolysis. Thereby, the uniform electrolytic dressing can be realized for each grinding action surface 22A.

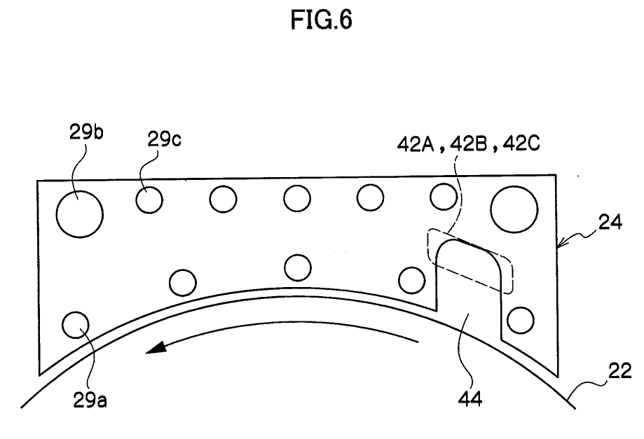

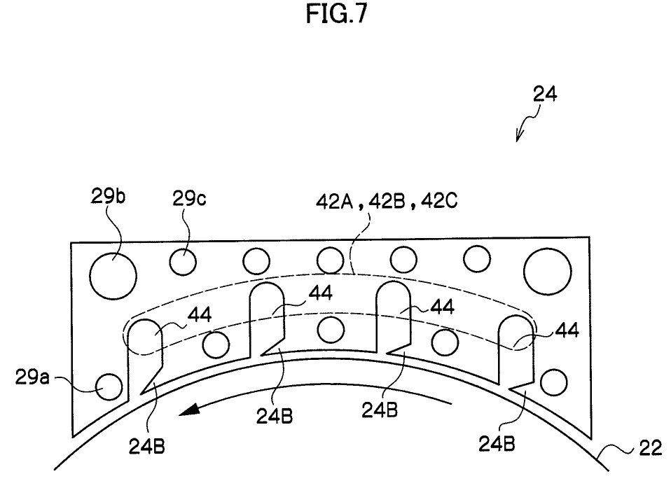

The structure of the electrode plate 24 is not limited to the mode of this embodiment but may employ an arbitrary mode as shown in FIGS. 6 and 7, for example. FIGS. 6 and 7 are diagrams illustrating variations of the electrode plate 24.

Since the vicinity of the grinding action surface of the conductive grinding wheel opposed to the opening of the notch portion forming the plurality of channels 44, . . . formed in the electrode plate 24 is actually a portion to which the machining fluid is supplied, there is a fear that the electrolytic area is made smaller and electrolysis becomes insufficient. Against that, in order to sufficiently ensure the electrode area opposed to the grinding action surface 22A of the conductive grinding wheel 22, as shown in FIG. 6, a somewhat large channel 44 is formed only on the upstream side in the rotating direction of the conductive grinding wheel 22. Thereby, the machining fluid can be supplied in a sufficient amount and the electrolytic area can be sufficiently ensured on the downstream side in the rotating direction of the conductive grinding wheel. In this case, on the insulating plates 26, 28, 30, 32, instead of the manifold long in the rotating direction of the conductive grinding wheel 22 as in FIG. 5, manifolds 42A, 42B, 42C (virtual line) with a small width similar to those formed on the electrode plate in FIG. 6 are formed.

Also, with rotation of the conductive grinding wheel 22, an air film is easily formed between the grinding action surface 22A of the grinding wheel 22 and the electrode action surface 24A of the electrode plate 24. If this air film is formed, the machining fluid is not sufficiently held between the grinding action surface 22A of the conductive grinding wheel 22 and the electrode action surface 24A of the electrode plate 24, and there is a fear of lack of electrolysis. Against that, as shown in FIG. 7, by providing a projection portion 24B tapered toward the rotating direction of the conductive grinding wheel 22 inside the opening of the channel 44, the machining fluid can be supplied in a large flow rate in the rotating direction of the conductive grinding wheel 22. Thereby, even if the supply flow rate of the machining fluid is small, the machining fluid can be sufficiently supplied between the grinding action surface 22A of the conductive grinding wheel 22 and the electrode action surface 24A of the electrode plate 24 and held therein. Also, since the opening area of the electrode plate 24 can be made small, the electrolytic area can be sufficiently ensured.

As mentioned above, according to this embodiment, even in the case of the multi-wheel grindstone 14 for grinding machining formed by assembling the plurality of different types of extremely thin conductive grinding wheels 22 to the rotating shaft with a predetermined interval, a machining-fluid holding space 25 can be formed for each grinding wheel for sufficiently holding the machining fluid between the electrode action surface 24A of each electrode plate 24 and the grinding action surface 22A of each conductive grinding wheel 22. Therefore, the grinding action surface 22A of each conductive grinding wheel 22 in the multi-wheel grindstone 14 can be uniformly electrolytic-dressed. Also, since the machining fluid can be uniformly distributed to each machining-fluid holding space 25, the machining fluid will not run short on the grinding action surface 22A of each conductive grinding wheel 22.

Also, since each electrode plate 24 is insulated by the insulating plates 26, 28, 30, 32, by sequentially switching the electrode plate 24 connected to the power supply 20 by the switching device 36, the grinding action surface 22A of the conductive grinding wheel 22 can be selectively electrolytic-dressed. That is, if a voltage is applied in the same condition between all the electrode plates 24 and all the grinding action surfaces 22A without providing the switching device 36, the smaller the abrasive grains of the conductive grinding wheel is, the more abrasive grains are chipped off with the oxidized film at the grinding machining and worn. Therefore, the conductive grinding wheel with small abrasive grains (such as a conductive grinding wheel for final finishing, for example) is preferably configured so that a voltage can be applied in a condition different from that for the other grinding wheels. In this way, according to the worn state of each grinding action surface, the electrolytic dressing for one electrode plate 24 can be carried out under an electrolytic condition independent from those for the other plates 24. As the electrolytic condition, a connected state (connection time, connection number of times) between the electrode plate 24 and the power supply 20 can be varied.

The preferred embodiments of the grinding device and the method according to the present invention have been explained above, but the present invention is not limited to the above embodiments but can employ various modes.

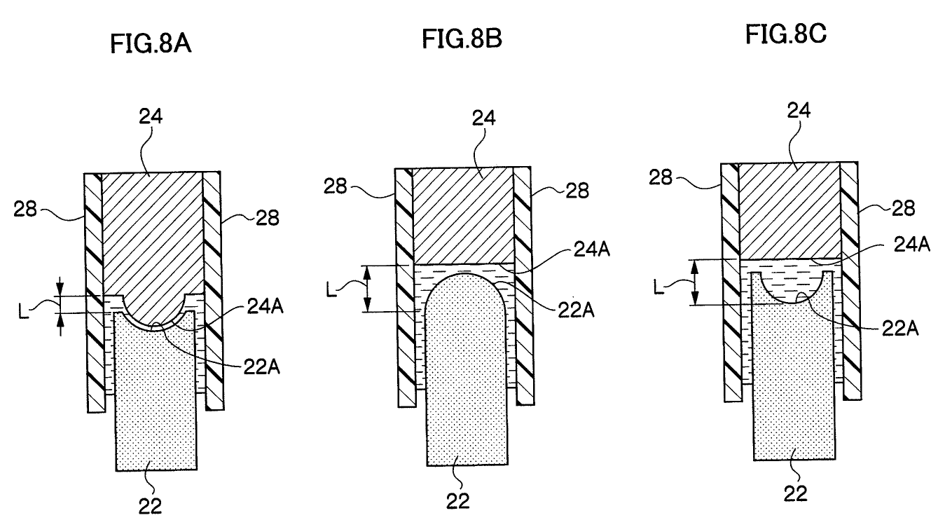

For example, in the above embodiments, as explained in the example in which both the grinding action surface of the conductive grinding wheel 22 and the electrode action surface 24A of the electrode plate 24 are flat, the grinding action surface 22A and the electrode action surface 24A are both preferably in a polygonal shape, but not limited to that, an arbitrary combination as shown in FIGS. 8A to 8C, for example, is possible.

FIG. 8A is an example in which the electrode action surface 24A of the electrode plate 24 is formed as an arc-shaped projection portion and the grinding action surface 22A of the conductive grinding wheel 22 is formed as an arc-shaped recess portion (form) through a given clearance from the electrode action surface 24A. FIG. 8B is an example in which the electrode action surface 24A of the electrode plate 24 is a planar shape (straight type) and the grinding action surface 22A of the conductive grinding wheel 22 is formed as an arc-shaped projection portion. FIG. 8C is an example in which the electrode action surface 24A of the electrode plate 24 is planar (straight type) and the grinding action surface 22A of the conductive grinding wheel 22 is formed as an arc-shaped recess portion (form). In this way, even if grinding action surface 22A of the conductive grinding wheel 22 takes various shapes, by applying the present invention, the machining fluid can be uniformly supplied to the grinding action surface 22A. The maximum interval L between the grinding action surface 22A of the conductive grinding wheel 22 and the electrode action surface 24A of the electrode plate 24 in each drawing will be illustrated. Grinding wheels with the shapes of the grinding action surfaces 22A different from each other may be combined for use.

In the above embodiments, the insulating plate constituting the electrode 16 for electrolysis is configured to have both the function to hold the machining fluid between that and the grinding action surfaces 22A of the grinding wheels and the function to uniformly distribute the machining fluid between that and the grinding action surfaces 22A of the grinding wheels, but not limited to that, these functions can be configured as separate members. For example, it may be so configured that a cell member for holding the machining fluid is installed at an upper part of the grinding action surface 22A and each electrode plate 24 is fitted into the cell member.

In the above embodiments, the example in which the switching device 36 includes the relay unit 38 and the controller 40 was explained, but not limited to that, it may be any configuration as long as each electrode plate 24 and the power supply 20 can be sequentially switched and connected.

Also, it was so configured that by providing the switching device 36, the voltage is applied only to the electrode plate opposed to the conductive grinding wheel during machining and only the conductive grinding wheel during machining is selectively electrolytic-dressed, but not limited to that. For example, all the conductive grinding wheels can be electrolytic-dressed at the same time without providing the switching device 36 but by connecting each electrode plate 24 in series.

Also, in the above embodiments, the example in which the multi-wheel grindstone in which the conductive grinding wheels with different roughness are combined is used was explained, but not limited to that, the multi-wheel grindstone may be configured by laminating a plurality of conductive grinding wheels of the same type (roughness, abrasive grain density and the like), for example. In this case, for example, the voltage is applied to all the conductive grinding wheels and all the conductive grinding wheels are used at the same time for grinding machining.

In the above embodiments, the example in which grinding machining is applied to the blade distal end portion of the blade coater as a work was explained but not limited to that, the present invention can be also preferably applied to grinding machining of a lip distal end portion of an extrusion die (work) with a form grindstone, for example.

In the above embodiments, the example in which the present invention may be applied in a planar grinding device was explained but not limited to that, the present invention can be also applied to other grinding devices such as a cylindrical grinding device, a centerless grinding device and the like, for example.

In addition, the object of the present invention can also be solved using the electrode according to any one of the embodiments, by replacing, with the electrode according to any one of the embodiments, an electrode used in a conventional grinding device with a multi-wheel grindstone in which a work being ground and machined while the grinding action surface of the multi-wheel grindstone is electrolytic-dressed by supplying machining fluid between an electrode action surface of the electrode and the grinding action surface of the multi-wheel grindstone.

While examples and embodiments of the present invention have been explained in detail, the present invention is not limited to the above. Needless to say, various improvements and modifications may be added without departing from the scope of the present invention.

What is claimed is:

1. A grinding device including a multi-wheel grindstone in which a plurality of conductive disk-shaped grinding wheels are arranged side by side with a predetermined interval along a rotating shaft and an electrode arranged opposite to a grinding action surface of the multi-wheel grindstone with an interval, in which a work is ground and machined while the grinding action surface of the multi-wheel grindstone is electrolytic-dressed by supplying conductive machining fluid between an electrode action surface of the electrode and the grinding action surface of the multi-wheel grindstone, and applying a voltage between the multi-wheel grindstone and the electrode, wherein
the electrode has a laminate body in which a plurality of electrode plates whose electrode action surfaces are arranged so as to oppose the grinding action surface of each of the grinding wheels are alternately sandwiched by a plurality of insulating plates, and
the electrode comprises a flow passage for distributing the machining fluid supplied into the laminate body to between the grinding action surface of each grinding wheel and the electrode action surface of the electrode plate is formed at the electrode plate and the insulating plate.

2. The grinding device according to claim 1, wherein
the flow passage comprises:
manifolds having an arc shape which are formed in the plurality of insulating plates along a rotating direction of the grinding wheels and expand a flow of the machining fluid introduced into the laminate body in a laminating direction of the laminate body and the rotating direction of the grinding wheels; and
channels which are formed as long-hole shaped notch portions at a plurality of positions on the plurality of electrode plates along the rotating direction of the grinding wheels, one end of the notch portions communicating with a corresponding manifold with the other end of the notch portions opened on the electrode action surface of the electrode plates.

3. The grinding device according to claim 2, further comprising
projecting portions inclined toward the rotating direction of the grinding wheels, inside the notch portions forming the channels.

4. The grinding device according to claim 1, wherein
the flow passage comprises:
manifolds which are formed at upstream positions in a rotating direction of the grinding wheels in the plurality of insulating plates and expand a flow of the machining fluid introduced into the laminate body in a laminating direction of the laminate body; and
channels which are formed as long-hole shaped notch portions at upstream positions in the rotating direction of the grinding wheels in the plurality of electrode plates, one end of the notch portions communicating with a corresponding manifold with the other end of the notch portions opened on the electrode action surface of the electrode plates.

5. The grinding device according to claim 1, wherein
the plurality of insulating plates have distal end portions projecting to the side of the grinding wheel rather than the electrode action surfaces; and
a machining-fluid holding space surrounding the grinding action surface for each grinding wheel of the multi-wheel grindstone is formed by the insulating plates which are adjacent with each other and sandwich the electrode plate therebetween.

6. The grinding device according to claim 1, wherein each of the grinding wheels is a form grinding wheel.

7. The grinding device according to claim 1, wherein a thickness of each grinding wheel is 5 mm or less.

8. The grinding device according to claim 1, wherein roughness of the grinding action surface is different for each grinding wheel.

9. The grinding device according to claim 1, further comprising
a switching device for switching conduction between a power supply for applying a voltage between each grinding wheel and the electrode, and each of the electrode plates.

10. A grinding method for carrying out grinding machining using the grinding device according to claim 1.

11. The grinding method according to claim 10, wherein the work is a distal end portion of a coater head.

12. The grinding method according to claim 10, wherein the work is a lip distal end portion of an extrusion die.

13. An electrode to be used for a grinding device including a multi-wheel grindstone in which a plurality of conductive disk-shaped grinding wheels are arranged side by side with a predetermined interval along a rotating shaft, the electrode arranged opposite to a grinding action surface of the multi-wheel grindstone with an interval, in which a work is ground and machined while the grinding action surface of the multi-wheel grindstone is electrolytic-dressed by supplying machining fluid between an electrode action surface of the electrode and the grinding action surface of the multi-wheel grindstone, and applying a voltage between the multi-wheel grindstone and the electrode conductive, the electrode comprising:
a laminate body in which a plurality of electrode plates whose electrode action surfaces are arranged so as to oppose the grinding action surface of each of the grinding wheels are alternately sandwiched by a plurality of insulating plates; and
a flow passage for distributing the machining fluid supplied into the laminate body to between the grinding action surface of each grinding wheel and the electrode action surface of the electrode plate is formed at the electrode plate and the insulating plate.
